(19) United States
(12) Patent Application Publication
(10) Pub. No.: US 2026/0160942 A1
(43) Pub. Date: Jun. 11, 2026

(54) VERTICAL AND LATERAL OPTICAL THREE-DIMENSIONAL INTERCONNECT FABRIC

(71) Applicant: University of Florida Research Foundation, Incorporated, Gainesville, FL (US)

(72) Inventors: Volker J. Sorger, Gainesville, FL (US); Hangbo Yang, Gainesville, FL (US); Md. Mahfuzur Rahman, Gainesville, FL (US)

(21) Appl. No.: 19/366,635

(22) Filed: Oct. 23, 2025

Related U.S. Application Data
(60) Provisional application No. 63/730,632, filed on Dec. 11, 2024.

(51) Int. Cl. G02B 6/122; G02B 6/12

(52) U.S. Cl. CPC G02B 6/122; G02B 2006/12104

(57) ABSTRACT

A micromirror-based method for light coupling in three dimensional (3D) photonic integrated circuits (PICs) is provided. The micromirror-based method provides for enhanced coupling efficiency and a reduced footprint in multi-layer PIC structures. The micromirror-based method provides for PIC structure designs that leverage waveguides with embedded micromirrors for vertical integration. The micromirror-based method provides for an iterative process of simulation and testing, coupled with a predictive digital twin model, enabling optimization and scalability in PIC applications.

### CROSS-REFERENCE TO RELATED APPLICATIONS

This application claims priority to U.S. Provisional Patent Application Ser. No. 63/730,632, filed on Dec. 11, 2024, the contents of which are hereby incorporated by reference in their entirety.

### TECHNICAL FIELD

Various embodiments of the present disclosure relate to photonic integrated circuits (PICs) and, more particularly, to methods and devices for improving light coupling between layers of three-dimensional (3D) PICs using micromirrors.

### BACKGROUND

In some PICs, transferring light between different layers of stacked PICs presents various challenges associated with efficiency, alignment, and compactness of the PICs. For instance, some PICs utilize coupling methods that use directional couplers or grating couplers, which are constrained in terms of optical loss and integration density. Such constraints may be exacerbated for some materials, such as glass, which are associated with relatively large waveguide dimensions. Additionally, some PIC-to-PIC coupling techniques suffer from insertion loss (IL), lack compactness, and have relatively high design complexity. As such, the fabrication of compact devices with low-loss vertical light coupling between PICs is becoming increasingly more difficult for manufacturers. Moreover, in some instances, glass or amorphous silicon may be used, which may lead to a relatively large footprint or excessive optical loss and reduce the performance of the 3D PIC structures.

### BRIEF SUMMARY

The present disclosure provides methods, systems, and apparatuses for improving light coupling between layers of 3D PICs using micromirrors. By using micromirrors to couple light between layers, the methods, systems, and apparatuses may provide for compact 3D structures with reduced optical loss, relatively small footprints, and improved performance.

In at least one example embodiment, an apparatus is provided comprising: a first waveguide having an in-plane orientation; a second waveguide having an out-of-plane orientation; and a micromirror coupled to the first waveguide, wherein the micromirror is configured to reflect an optical signal between the first waveguide and the second waveguide.

In at least one example embodiment, at least one of the first waveguide or the second waveguide comprises a material selected from the group consisting of: a silicon material, a silicon nitride material, a material comprising a group III element and a group V element, an oxide material, and a polymer material.

In at least one example embodiment, the first waveguide comprises a crystalline material.

In at least one example embodiment, the second waveguide is positioned vertically above the first waveguide.

In at least one example embodiment, the micromirror comprises a surface in the first waveguide, wherein the surface is positioned at an angle.

In at least one example embodiment, a reflective material is deposited on the surface.

In at least one example embodiment, the micromirror is associated with an insertion loss that is based at least in part on the angle and a curvature of the micromirror.

In at least one example embodiment, the micromirror is flat or concave.

In at least one example embodiment, the micromirror is configured to focus the optical signal.

In at least one example embodiment, a method for fabricating an apparatus in accordance with a fabrication process is provided, wherein the fabrication process comprises forming the micromirror in the first waveguide via wet etching or grayscale lithography.

In at least one example embodiment, the fabrication process comprises forming the micromirror in the first waveguide via the wet etching, and wherein the micromirror is flat based at least in part on forming the micromirror via the wet etching.

In at least one example embodiment, the fabrication process comprises forming the micromirror in the first waveguide via the grayscale lithography, and wherein the micromirror is flat or concave based at least in part on forming the micromirror via the grayscale lithography.

In at least one example embodiment, the method comprises obtaining a prediction of a level of performance of a three dimensional photonic circuit including the apparatus via a machine learning model.

In at least one example embodiment, the machine learning model comprises a predictive digital twin model configured to predict one or more levels of performance based at least in part on one or more parameters associated with the fabrication process.

In at least one example embodiment, the machine learning model is trained using data associated with the fabrication process.

In at least one example embodiment, the data comprises information pertaining to at least one of the following: one or more materials associated with the first waveguide, one or more materials associated with the second waveguide, one or more angles associated with the micromirror, one or more curvature values associated with the micromirror, a fabrication method used to form the micromirror, one or more types of reflective material deposited on at least one surface of the micromirror, one or more shapes associated with the first waveguide, one or more shapes associated with the second waveguide, or a fabrication method used to couple the first waveguide to the second waveguide.

In at least one example embodiment, a photonic integrated circuit device is provide comprising: at least two waveguide layers; at least one micromirror configured to transfer an optical signal between the at least two waveguide layers; and a digital twin system configured to predict one or more performance outcomes based at least in part on one or more parameters associated with a fabrication process used to fabricate at least a portion of the photonic integrated circuit device.

In at least one example embodiment, the portion of the photonic integrated circuit device comprises the at least two waveguide layers and the at least one micromirror.

In at least one example embodiment, the one or more parameters comprise at least one of the following: one or more materials associated with each waveguide layer of the at least two waveguide layers, one or more angles associated with the at least one micromirror, one or more curvature values associated with the at least one micromirror, a fabrication method used to form the at least one micromirror, one or more types of reflective material deposited on at least one surface of the at least one micromirror, one or more shapes associated with at least two waveguides in the at least two waveguide layers, or a fabrication method used to couple the at least two waveguide layers.

In at least one example embodiment, the at least two waveguide layers comprise a first waveguide layer and a second waveguide layer, and wherein the first waveguide layer comprises an in-plane waveguide and the second waveguide layer comprises an out-of-plane waveguide.

The above summary is provided merely for purposes of summarizing at least some example embodiments to provide a basic understanding of some aspects of the disclosure. Accordingly, it will be appreciated that the above-described embodiments are merely examples and should not be construed to narrow the scope of the disclosure in any way. It will also be appreciated that the scope of the disclosure encompasses many potential embodiments in addition to those summarized here, some of which will be further described below.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 illustrates an example platform to which one or more examples disclosed herein may be applied; and

FIGS. 2A and 2B illustrate example simulation results to which one or more examples disclosed herein may be applied.

### DETAILED DESCRIPTION

Some embodiments of the present disclosure will now be described more fully herein with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in various embodiments,” “in one embodiment,” “according to one embodiment,” “in some embodiments,” and the like, generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

The use of the term “circuitry” as used herein with respect to components of a system or an apparatus should be understood to include particular hardware configured to perform the functions associated with the particular circuitry as described herein. The term “circuitry” should be understood broadly to include hardware and, in some embodiments, software for configuring the hardware. For example, in some embodiments, “circuitry” may include processing circuitry, communications circuitry, input/output circuitry, and the like. In some embodiments, other elements may provide or supplement the functionality of particular circuitry.

### Overview

The present disclosure pertains to the field of PICs and, more specifically, to methods and devices for improving light coupling between layers of 3D PICs using micromirrors. For example, in some PICs, transferring light between different layers of stacked PICs presents various challenges with respect to efficiency, alignment, and compactness. That is, some PICs may utilize coupling methods that use directional couplers or grating couplers, which may be associated with increased optical loss and reduced integration density for various materials, such as materials with relatively large waveguide dimensions (e.g., glass). Some coupling techniques (e.g., PIC-to-PIC coupling techniques) may suffer from insertion loss (IL), compactness, and design complexity, making the fabrication of compact PIC devices with low-loss vertical light coupling between PICs increasingly more difficult. While various methods, such as those that use glass or amorphous silicon, have been proposed, these techniques may result in a relatively large footprint and/or excessive optical loss, thereby reducing performance in relatively dense 3D PIC structures.

Various aspects of the present disclosure provide a micromirror-based method for light coupling in 3D PICs, which enhances coupling efficiency and reduces the footprint of multi-layer PIC structures. In some examples, the present disclosure provides for PIC designs that leverage waveguides (e.g., silicon and/or silicon nitride waveguides) with embedded micromirrors for vertical integration. Additionally, in some examples, the present disclosure provides for an iterative process of simulation and testing, coupled with a predictive digital twin model, which enables optimization and scalability in various PIC applications.

In some examples, the present disclosure provides for an approach using crystalline Si and SiNₓ waveguides (or one or more other types of waveguides) with integrated micromirrors to enable light transfer between horizontal and vertical waveguides in 3D PICs. In some such examples, the present disclosure provides for optimization of the micromirror design, which enhances coupling efficiency, reduces device footprint, and supports broadband operation for various applications, such as wavelength division multiplexing (WDM) applications. The techniques provided herein therefore enable the development of compact, high-performance photonic circuits with enhanced functionality and integration density.

In some examples, the present disclosure provides for an iterative process of simulation, fabrication, and testing, which may be employed to refine micromirror design. For example, the process may be used to reduce (e.g., minimize) insertion loss to below a threshold (e.g., about 0.5 dB per facet) through by iterative adjustments to the micromirror design. In some examples, the present disclosure provides for a system that leverages a digital twin model to predict device performance based on fabrication parameters, thereby enhancing process accuracy and device reliability.

### Exemplary Systems, Apparatuses, and Methods

In some instances, heterogenous computer chips may be stacked to improve system performance. For example, such stacking may lead to a 100× improvement in compute performance. As such, some computer chips may be based on 3D stacking of heterogenous chips. In some other instances, PICs may be used to improve system performance. For example, some PICs may enable transmission of relatively large (e.g., massive) amounts of data in a compact chip-packaged formfactor. In some instances, however, optical signals may (only) be sent or routed in-plane. For example, optical signals in some PICs may be routed in-plane (e.g., horizontally) via a silicon-on-insulator layer or a silicon nitride-on-insulator layer. Thus, such PICs may be unable to route optical signals out-of-plane (e.g., vertically). As such, some PICs may not be suitable for a 3D stacked chip package.

Various aspects of the present disclosure provide for systems, apparatuses, and methods for transferring optical signals (e.g., light) between in-plane and out-of-plane waveguides in photonic circuits, such as 3D PICs. In some examples, a system of the present disclosure may include a compact, spectrally broadband, and low-optical loss micromirror that couples light from an in-plane waveguide to an out-of-plane waveguide (also referred to as an optical via). The micromirror may be embedded in (e.g., carved into, cut into) the in-plane waveguide at an angle of about 45 degrees relative to the plane of the first waveguide (e.g., relative to the horizontal plane). In some examples, the out-of-plane waveguide (e.g., a vertical waveguide) may be formed of a material having a higher optical index than a host material of the out-of-plane waveguide. In other words, the material forming the out-of-plane waveguide may have a higher optical index than a material surrounding the out-of-plane waveguide, which may enable optical signals to be routed through the out-of-plane waveguide. In some examples, the out-of-plane waveguide may be coupled to the in-plane waveguide to match the optical mode of the in-plane waveguide (or vice versa).

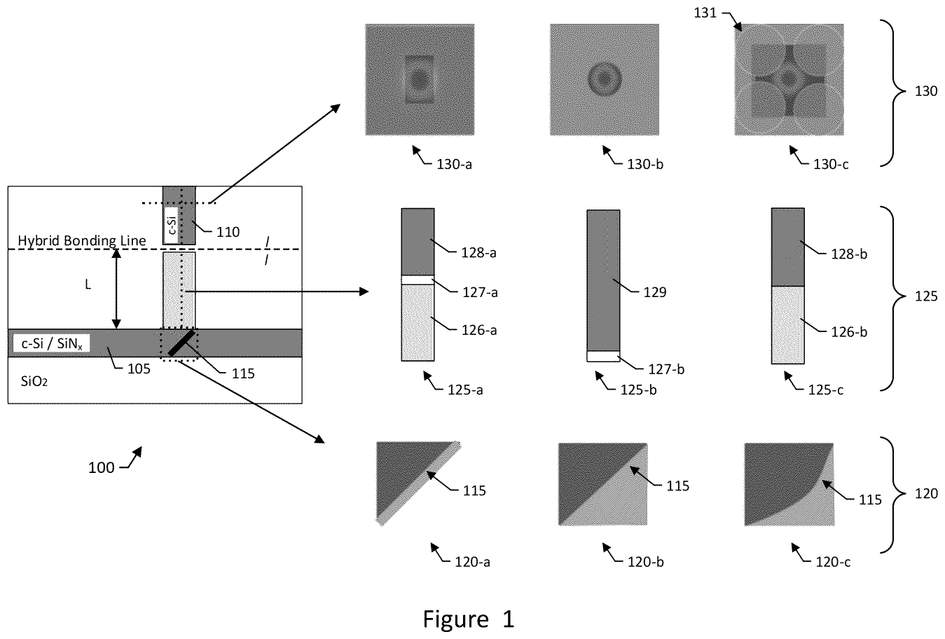

FIG. 1 illustrates an example platform 100 (e.g., an apparatus) to which one or more examples disclosed herein may be applied. As illustrated in the example of FIG. 1, the platform 100 may include one or more horizontal waveguides and one or more vertical waveguides. In the example of FIG. 1, the platform 100 includes an in-plane waveguide 105 (e.g., a horizontal waveguide) and an out-of-plane waveguide 110 (e.g., a vertical waveguide). The in-plane waveguide 105 and the out-of-plane waveguide 110 may be used for 3D photonic integration. In some examples, the in-plane waveguide 105 and/or the out-of-plane waveguide 110 may be formed from a silicon (Si) material, such as crystalline silicon (c-Si) or amorphous silicon (a-Si). Additionally, or alternatively, the in-plane waveguide 105 and/or the out-of-plane waveguide 110 may be formed from a silicon nitride (SiNₓ) material, such as Si₃N₄ or another type of SiNₓ material. As illustrated in the example of FIG. 1, the out-of-plane waveguide 110 (e.g., the vertical waveguide made of a deposited material, such as Si, SiNx, etc.) has a thickness (L). In some examples, as illustrated in the example of FIG. 1, an SiO₂ layer with a thickness (l) may be deposited on one or more sides (e.g., each side) of the hybrid bonding line for direct bonding.

In some examples, the platform 100 may combine one or more horizontal (in-plane) Si or SiNₓ waveguides with one or more vertical (out-of-plane) c-Si waveguides for 3D photonic integration. The out-of-plane waveguide 110 may be formed using etching (e.g., deep etching). For example, vertical waveguides may utilize deep etching and hybrid bonding may be used to facilitate layer integration. In some examples, by integrating the in-plane waveguide 105 and the out-of-plane waveguide 110, the platform 100 may provide for compact, high-performance optical interconnects. The platform 100 may also include one or more micromirrors (e.g., a micromirror 115), which may be fabricated via various techniques. In the example of FIG. 1, micromirror 115 may couple light between the in-plane waveguide 105 and the out-of-plane waveguide 110.

In some examples, horizontal waveguides may be fabricated using c-Si or SiNₓ. In other words, as illustrated in the example of FIG. 1, horizontal waveguides, such as the in-plane waveguide 105, may be fabricated using c-Si or SiNₓ.

In some examples, aluminum (Al) or silver (Ag) may be used as materials for micromirrors, which may have flat and/or concave shapes, as shown in FIG. 1. For example, three options may be used for the micromirror fabrication, including a first option (a), a second option (b), and a third option (c). Option (a) includes a flat micromirror with c-Si, fabricated using a 4-wave ion beam etching (IBE) mill with a 45-degree tilt. In some examples, this option utilizes a c-Si substrate with an air gap beneath the micromirror. Option (b) includes a flat micromirror with a-Si, fabricated using grayscale lithography with either photon or electron beams, featuring a c-Si substrate and an a-Si layer above, tilted at 45 degrees. Option (c) includes a concave micromirror with amorphous Si, fabricated similarly to option (b) using grayscale lithography, but with a concave micromirror shape.

In other words, for micromirrors such as the micromirror 115, aluminum (Al) or silver (Ag) materials may be used and the micromirrors may have a flat or concave shape. As illustrated in FIG. 1, the micromirror 115 may be fabricated in accordance with one or more shapes 120 (e.g., shape 120-a, shape 120-b, or shape 120-c). In accordance with shape 120-a, the micromirror 115 may be a flat micromirror formed from c-Si. For example, the micromirror 115 may be fabricated in accordance with shape 120-a, using a 4-wave IBE mill with a 45-degree tilt. In some examples, to achieve shape 120-a, a c-Si substrate may be utilized with an air gap beneath the micromirror 115. In accordance with shape 120-b, the micromirror 115 may be a flat micromirror formed from a-Si. For example, the micromirror 115 may be fabricated in accordance with shape 120-b, using grayscale lithography with photon or electron beams, featuring a c-Si substrate and an a-Si layer above, tilted at 45 degrees. In accordance with shape 120-c, the micromirror 115 may be a concave micromirror formed from a-Si. For example, the micromirror 115 may be fabricated in accordance with shape 120-c, using grayscale lithography (e.g., in a similar manner as is used to achieve shape 120-b) with a concave micromirror shape.

In some examples, for vertical waveguides, three shape options may be considered: (I) a rectangular shape, (II) a round shape, and (III) a star shape. The rectangular shape (I) may be analogous to horizontal waveguides but may pose greater fabrication challenges due to etching depth and width ratio. The round shape (II) may offer fabrication simplicity, but potentially less stable during transfer processes. The star shape (III) may feature four rounded etchings, which may provide a balance of fabrication feasibility and transfer stability.

As illustrated in the example of FIG. 1, vertical waveguides (e.g., the out-of-plane waveguide 110) may have one or more shapes. For example, the out-of-plane waveguide 110 may have one of the shapes 130. In some examples, the out-of-plane waveguide 110 may have a rectangular shape (e.g., shape 130-a), which may be analogous to the shape of the horizontal waveguide (e.g., the in-plane waveguide 105). In some examples, the shape 130-a may pose greater fabrication challenges due to the etching depth and width ratio. In some other examples, the out-of-plane waveguide 110 may have round shape (e.g., shape 130-b), which may offer fabrication simplicity, but may be potentially less stable during transfer processes. In some examples, the out-of-plane waveguide 110 may have a star shape (e.g., shape 130-c), which may feature four rounded etchings 131. The four rounded etchings 131 may provide the out-of-plane waveguide 110 with a balance of fabrication feasibility and transfer stability.

In some examples, three packaging options may be available to integrate horizontal and vertical waveguides. A first packing option (1) may include an amorphous Si/SiNₓ transition layer with hybrid bonding, depositing an amorphous Si or SiNₓ layer as a vertical waveguide to provide mode stability, followed by hybrid bonding to the c-Si vertical waveguides (fabricated via deep etching) with a 100 nm SiO2 interlayer. A second packing option (2) may include direct hybrid bonding, where the horizontal c-Si waveguides are directly bonded to the c-Si vertical waveguides (fabricated via deep etching) with a 100 nm SiO2 interlayer. A third packing option (3) may include an amorphous Si/SiNₓ transition layer with direct hybrid bonding, which may be similar to the first packing option (1), but without the 100 nm SiO2 interlayer, which may potentially pose experimental challenges.

As illustrated in the example of FIG. 1, one of packing types 125 may be used to integrate horizontal waveguides (e.g., the in-plane waveguide 105) and vertical waveguides (e.g., the out-of-plane waveguide 110). For example, a packing type 125-a may be used, which includes an amorphous Si/SiNₓ transition layer 126-a with hybrid bonding. In such an example, the amorphous Si/SiNₓ transition layer 126-a may be deposited as a vertical waveguide layer to provide mode stability, followed by hybrid bonding to a c-Si vertical waveguide layer 128-a (fabricated via deep etching) with a 100 nm SiO₂ interlayer 127-a. In some other examples, a packing type 125-b may be used, which includes a direct hybrid bonding layer 129. In some such examples, the direct hybrid bonding layer 129 includes a horizontal c-Si waveguide layer directly bonded to a c-Si vertical waveguide layer (fabricated via deep etching) with a 100 nm SiO₂ interlayer 127-b. In some examples, a packing type 125-c may be used, which includes an amorphous Si/SiNₓ transition layer 126-b with direct hybrid bonding. In some such examples (similar to the packing type 125-a, but without the 100 nm SiO₂ interlayer), the amorphous Si/SiNₓ transition layer 126-b may be deposited as a vertical waveguide layer to provide mode stability, followed by hybrid bonding to a c-Si vertical waveguide layer 128-b (fabricated via deep etching).

In some examples, the present disclosure provides a systematic evaluation of an approach for achieving high-performance, compact 3D photonic integration. In some examples, the present disclosure provides for a design featuring a c-Si horizontal waveguide; tilted, flat metal (or metallized) micromirrors; vertical waveguides with a high-index material, such as Si, SiNₓ, or a III-V semiconducting material (also referred to as a III-V semiconductor) with a rectangular shape, matching the horizontal waveguide; and waveguide integration that includes direct bonding of the horizontal and vertical crystalline waveguides with a relatively thin oxide interlayer (e.g., about 100 nm).

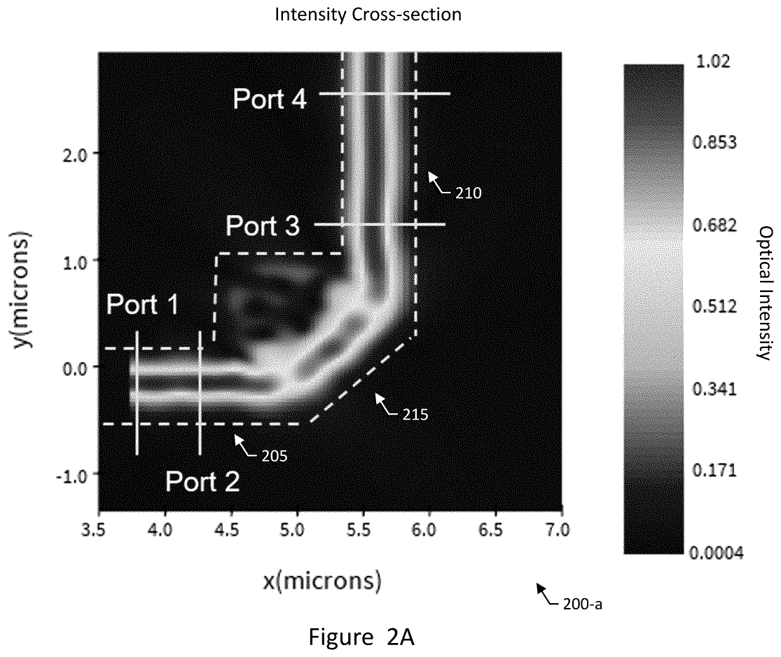

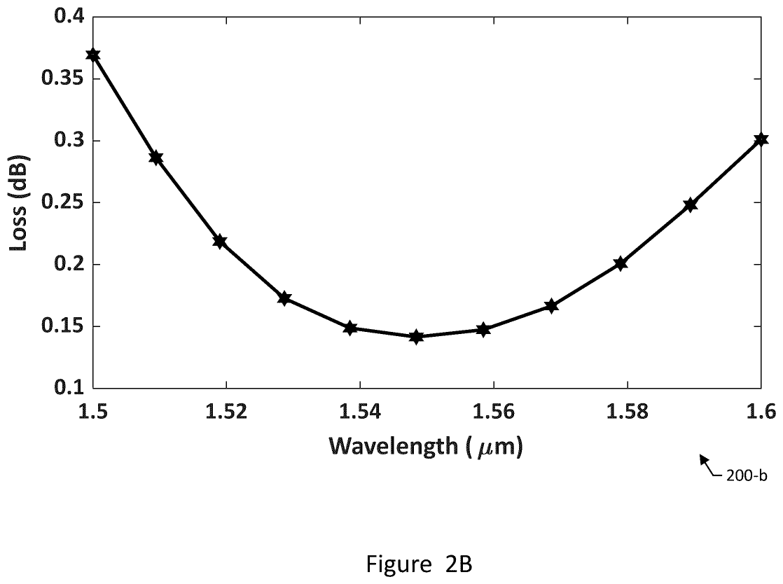

FIGS. 2A and 2B illustrate example simulation results 200 (e.g., simulation results 200-a and simulation results 200-b) to which one or more examples disclosed herein may be applied. In the example of FIGS. 2A and 2B, the simulation results 200 are for a configuration including the shape 130-a, the packing type 125-b, and the shape 120-a, as described with reference to FIG. 1. For example, FIG. 2A illustrates two c-Si waveguides (an in-plane waveguide 205, an out-of-plane waveguide 210 with a length of about 2 microns (μm)) with a 45-degree flat Al micromirror (e.g., a micromirror 215) and direct bonding. As illustrated in the example of FIG. 2A, an optical signal is provided to an input port (port 1) of the in-plane waveguide 205. As shown by the optical light intensity of the optical signal, the optical signal propagates through the in-plane waveguide 205 and is reflected by the micromirror 215 from the in-plane waveguide 205 to the out-of-plane waveguide 210. In the example of FIG. 2B, the configuration of FIG. 2A provides an average insertion loss (i.e., transmission loss) of about 0.66 dB in simulated 3D photonic integration for a broadband from 1.5 to 1.6 μm. As used herein, insertion loss refers to the loss of signal power (in decibels (dB)) from the insertion of the crossing from the input port (port 1) to one or more output ports (port 2, port 3 and port 4). As used herein, the crossing refers to a point where two waveguides intersect each other. In some examples, the crossing provides a path for the optical signal to propagate from one waveguide to another.

It is to be understood that the types of materials referred to in the examples of FIGS. 1, 2A, and 2B are exemplary and the systems, apparatuses, and methods described herein may be applied to other types of materials. For example, a micromirror may include a reflective surface and non-limiting examples of elements used to form the reflective surface include Al, tungsten (W), copper (Cu), Ag, and gold (Au). Additionally, non-limiting examples of a material used to form an in-plane waveguide and/or an out-of-plane waveguide include one or more Si materials, one or more SiNₓ materials, one or more III-V semiconducting materials, and one or more oxide materials. Non-limiting examples of the host material for an in-plane waveguide and/or an out-of-plane waveguide include SiO₂, Al₂O₃, HfO₂, air, and SiNₓ.

In some examples, in accordance with one or more aspects of the present disclosure, waveguide design and materials may include the use of Si (e.g., a-Si or c-Si), SiNₓ, a III-V semiconductor, an oxide material, or a polymer for one or more horizontal waveguides and the use of c-Si for one or more vertical waveguides to, for example, improve light confinement and reduce (e.g., minimize) losses. In some examples, the oxide material includes SiO₂, HfO₂, or Al₂O₃, among other examples of oxides. In some examples, the polymer includes an ultraviolet (UV) curable (UV-curable) polymer (e.g., Su-8), a photopatternable epoxy material (e.g., EpoCore/EpoClad), a siloxane material, a fluoropolymer (e.g., Cytop), or a cyclic olefin copolymer (COC), among other examples.

In some examples, micromirror integration in accordance with one or more aspects of the present disclosure may include a design of concave and/or flat micromirrors embedded at the intersection of one or more horizontal waveguides and one or more vertical waveguides. Example parameters for a micromirror configuration include curvature, angle, diameter, and alignment for an improved (e.g., maximum) coupling efficiency and reduced (e.g., minimal) footprint. In other words, the performance of the micromirror may be based on the curvature, angle, diameter, and/or alignment of the micromirror.

In some examples, as is illustrated in FIGS. 2A and 2B, an Ansys-Lumerical finite-difference time-domain (FDTD) simulation may be used to model light propagation through waveguides and micromirrors. In some such examples, iterative adjustments based on experimental feedback may be used to adjust (e.g., refine) the micromirror design and improve coupling performance. In some examples, the experimental feedback includes optical power loss measurements and/or spectral content.

In some examples, fabrication techniques in accordance with one or more aspects of the present disclosure include wet etching (e.g., for flat mirrors) and grayscale lithography (e.g., for concave mirrors). Additionally, in some examples, high-precision foundry techniques (e.g., AIM Photonics chip foundry, Global Foundries chip foundry) may be used to manufacture waveguides and micromirrors. For example, one or more flat mirrors may be fabricated in a waveguide (e.g., in an Si waveguide) via ion-milling, such as may be performed at the National Institute of Standards and Technology (NIST) at Gaithersburg, MD. The systems described herein may provide for arbitrary angle definition. In some examples, a ‘cavity’ formed for a micromirror (e.g., via a cut in a horizontal waveguide) may be metallized using complementary metal oxide-near (CMOs-near) materials such as Al. In some examples, to lower optical losses, Au or Ag may be used (e.g., if the system tolerates such materials). In some other examples, the micromirror may lack a metal layer. For example, the micromirror may achieve a relatively high efficiency (e.g., above 90%) both with and without a metal layer. In some such examples, the micromirror may exhibit an efficiency of about 96% without a metal layer.

In some examples, a-Si may be deposited above a flat mirror. In some such examples, the a-Si may be deposited (e.g., at high quality) via low pressure chemical vapor deposition (LPCVD).

In some examples, fibers, on-chip grating couplers or edge couplers, lasers, and/or photodetectors may be used for assessing coupling efficiency and insertion loss of waveguides. Additionally, in some examples, scanning electron microscopy (SEM) and focused ion beam (FIB) may be used to characterize the surface profile, roughness, and/or misalignment of a micromirror. Comparative data may be used to show improvements in coupling efficiency and footprint reduction provided by the present disclosure over other light coupling methods, such as coupling methods that use directional couplers or grating couplers.

In some examples, a characterization strategy may be employed to assess the performance of devices fabricated in accordance with one or more aspects of the present disclosure. Such a characterization strategy may include optical characterization, which utilizes fiber-based measurements, on-chip grating couplers or edge couplers, lasers, and/or photodetectors to quantify coupling efficiency and insertion loss. Additionally, or alternatively, the characterization strategy may include microscopy and/or imaging, including SEM and FIB imaging techniques, which may be used to analyze the surface profile, roughness, and misalignment of fabricated micromirrors. In some examples, a comparative analysis may be conducted to demonstrate the improvements in coupling efficiency and footprint reduction provided by the present disclosure relative to other light coupling methods, such as directional couplers or grating couplers. In some examples, a machine-learning-based digital twin model may be used to predict fabrication outcomes (e.g., the performance of the resultant structure) and improve (e.g., optimize) fabrication processes. In some such examples, the integration of real-time data obtained from fabrication and characterization techniques may be used to enhance design predictability.

In at least one embodiment, the present disclosure provides for apparatus, systems, and methods for efficient light coupling in 3D PICs. For example, the present disclosure provides for an apparatus comprising a first waveguide made from c-Si, SiNₓ, a III-V semiconductor, an oxide, or a polymer material. In such an example, the apparatus also comprises a second waveguide made from Si, SiNₓ, a III-V semiconductor, an oxide, or a polymer material. The second waveguide may be stacked vertically above the first waveguide. For example, the first waveguide may be oriented in-plane (e.g., horizontally) and the second waveguide may be oriented out-of-plane (e.g., vertically), such that, when the second waveguide is stacked (i.e., positioned) above the first waveguide, the first waveguide and the second waveguide form an angle of about 90°. As used herein, positioning (or stacking) the second waveguide vertically above the first waveguide means positioning a second surface of the second waveguide above (i.e., on top of) a first surface of the first waveguide. In some examples, at least a portion of the first surface of the first waveguide may be in contact with at least a second portion of the second surface of the second waveguide, such that the first waveguide and the second waveguide may intersect. In some examples, the apparatus further comprises a micromirror. In some such examples the micromirror may be coupled to the first waveguide. For example, the micromirror may be embedded in or otherwise incorporated into the first waveguide, such that the micromirror reflects light between the first and the second waveguides. In some examples, the micromirror may be defined as an angled cut into the first waveguide. A surface formed by the cut in the first waveguide (e.g., the micromirror) may be covered by a relatively thin reflective film (e.g., with a thickness of about 20±10 nm).

In at least one embodiment, an apparatus is provided comprising a first waveguide having an in-plane orientation (e.g., a horizontal waveguide); a second waveguide having an out-of-plane orientation (e.g., a vertical waveguide); and a micromirror coupled to the first waveguide, where the micromirror is configured to reflect an optical signal (e.g., light) between the first waveguide and the second waveguide. In at least one embodiment, the micromirror comprises a surface in the first waveguide (e.g., formed by the cut), where the surface is positioned at an angle, and where a reflective material is deposited on the surface.

In at least one embodiment, the first waveguide and/or the second waveguide comprises a material selected from the group consisting of: a silicon material (e.g., crystalline silicon, amorphous silicon), a silicon nitride material of formula SiNₓ, a material comprising a group III element and a group V element (e.g., a III-V semiconductor), an oxide material, and a polymer material. In other words, the first waveguide and/or the second waveguide may include Si, SiNx, a III-V semiconductor, an oxide, or a polymer. In at least one embodiment, the first waveguide comprises a crystalline material. In at least one embodiment, the second waveguide is positioned vertically above the first waveguide.

In at least one embodiment, the micromirror is concave or flat, with a particular curvature and angle that reduce (e.g., minimize) insertion loss between the first and second waveguides, thereby providing a relatively light beam focus. In other words, in at least one embodiment, the micromirror is flat or concave and the micromirror is associated with an insertion loss that is based at least in part on the angle and a curvature of the micromirror. In at least one embodiment, the micromirror is configured to focus the light reflected between the first waveguide and the second waveguide. In at least one embodiment, the angle has a value between 0 and 90°. In at least one embodiment, the micromirror comprises a surface (e.g., any flat or curved surface) of the first waveguide. In at least one embodiment, the micromirror is formed via ion milling.

In at least one embodiment, a method for fabricating the apparatus (e.g., a photonic device) is provided, where the method includes wet etching for flat micromirrors and grayscale lithography for concave micromirrors. In other words, in at least one embodiment, a method for fabricating the apparatus in accordance with a fabrication process is provided, where the fabrication process comprises forming the micromirror in the first waveguide via wet etching or grayscale lithography. In at least one embodiment, the fabrication process comprises forming the micromirror in the first waveguide via the wet etching, and the micromirror is flat based on forming the micromirror via the wet etching. In other words, in at least one embodiment, a flat micromirror may be formed via wet etching. In at least one other embodiment, the fabrication process comprises forming the micromirror in the first waveguide via the grayscale lithography, and the micromirror is concave or flat based on forming the micromirror via the grayscale lithography. In other words, in at least one embodiment, a flat or curved micromirror may be formed via grayscale lithography.

In at least one embodiment, a digital twin model is used for predicting the fabrication performance of the photonic device (e.g., a 3D photonic circuit), based on machine learning algorithms trained on data from the fabrication process. In other words, in at least one embodiment, the method includes obtaining a prediction of a level of performance of a three dimensional photonic circuit including the apparatus via a machine learning model. In at least one embodiment, the predicted level of performance corresponds to at least one of the following: a predicted insertion loss, a predicted optical loss, a predicted extinction ratio, a predicted operation bandwidth, a predicted signal-to-noise ratio (SNR), a predicted modulation efficiency, a predicted switching speed, a predicted power consumption per bit, a predicted polarization dependence, or a predicted level of crosstalk.

In at least one embodiment, the machine learning model comprises a predictive digital twin model configured to predict one or more levels of performance based on one or more parameters associated with the fabrication process. In at least one example embodiment, the machine learning model is trained using data associated with the fabrication process.

In at least one embodiment, a photonic integrated circuit device is provided comprising at least two layers of waveguides; at least one integrated micromirror positioned to facilitate efficient light transfer between the waveguide layers; and a digital twin system for predicting performance outcomes based on specific fabrication parameters. As used herein, a digital twin system refers to a system (e.g., a machine learning system) configured to apply a digital twin model for predicting performance outcomes. In other words, in at least one embodiment, a photonic integrated circuit device is provided comprising at least two waveguide layers; at least one micromirror configured to transfer an optical signal (e.g., light) between the at least two waveguide layers; and a digital twin system configured to predict one or more performance outcomes based on one or more parameters associated with a fabrication process used to fabricate at least a portion of the photonic integrated circuit device. In at least one example embodiment, the portion of the photonic integrated circuit device comprises the at least two waveguide layers and the at least one micromirror.

In at least one example embodiment, the one or more parameters comprise at least one of the following: one or more materials associated with each waveguide layer of the at least two waveguide layers (e.g., whether the first and/or second waveguide includes Si, SiNₓ, a III-V semiconductor, an oxide, or a polymer), one or more angles associated with the at least one micromirror, one or more curvature values associated with the at least one micromirror, a fabrication method used to form the at least one micromirror (e.g., whether the at least one micromirror is formed using wet etching or grayscale lithography), one or more types of reflective material deposited on at least one surface of the at least one micromirror (e.g., whether the thin reflective layer is made of Al, Au, or Ag), one or more shapes associated with at least two waveguides in the at least two waveguide layers (e.g., whether the first waveguide and/or the second waveguide has a rectangular shape, round shape, or star shape), or a fabrication method used to couple the at least two waveguide layers (e.g., whether the first waveguide and/or the second waveguide are integrated using an amorphous Si/SiNₓ transition layer with hybrid bonding, direct hybrid bonding, or an amorphous Si/SiNₓ transition layer with direct hybrid bonding).

In at least one example embodiment, the at least two waveguide layers comprise a first waveguide layer and a second waveguide layer, where the first waveguide layer comprises an in-plane waveguide (e.g., a horizontal waveguide) and the second waveguide layer comprises an out-of-plane waveguide (e.g., a vertical waveguide).

While this specification contains many specific embodiments and implementation details, these should not be construed as limitations on the scope of any disclosures or of what may be claimed, but rather as descriptions of features specific to particular embodiments of particular disclosures. Various features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

While operations and/or functions are illustrated in the drawings in a particular order, this should not be understood as requiring that such operations and/or functions be performed in the particular order shown or in sequential order, or that all illustrated operations be performed, to achieve desirable results. In certain circumstances, operations and/or functions in alternative ordering may be advantageous. In some cases, the actions recited in the claims may be performed in a different order and still achieve desirable results. Thus, while particular embodiments of the subject matter have been described, other embodiments are within the scope of the following claims.

While this detailed description has set forth some embodiments of the present disclosure, the appended claims cover other embodiments of the present disclosure which differ from the described embodiments according to various modifications and improvements.

Within the appended claims, unless the specific term “means for” or “step for” is used within a given claim, it is not intended that the claim be interpreted under 35 U.S.C. § 112, paragraph 6.

What is claimed is:

1. An apparatus, comprising:
a first waveguide having an in-plane orientation;
a second waveguide having an out-of-plane orientation; and
a micromirror coupled to the first waveguide, wherein the micromirror is configured to reflect an optical signal between the first waveguide and the second waveguide.

2. The apparatus of claim 1, wherein at least one of the first waveguide or the second waveguide comprises a material selected from the group consisting of: a silicon material, a silicon nitride material, a material comprising a group III element and a group V element, an oxide material, and a polymer material.

3. The apparatus of claim 1, wherein the first waveguide comprises a crystalline material.

4. The apparatus of claim 1, wherein the second waveguide is positioned vertically above the first waveguide.

5. The apparatus of claim 1, wherein the micromirror comprises a surface in the first waveguide, wherein the surface is positioned at an angle.

6. The apparatus of claim 5, wherein a reflective material is deposited on the surface.

7. The apparatus of claim 5, wherein the micromirror is associated with an insertion loss that is based at least in part on the angle and a curvature of the micromirror.

8. The apparatus of claim 1, wherein the micromirror is flat or concave.

9. The apparatus of claim 1, wherein the micromirror is configured to focus the optical signal.

10. A method for fabricating the apparatus of claim 1 in accordance with a fabrication process, wherein the fabrication process comprises forming the micromirror in the first waveguide via wet etching or grayscale lithography.

11. The method of claim 10, wherein the fabrication process comprises forming the micromirror in the first waveguide via the wet etching, and wherein the micromirror is flat based at least in part on forming the micromirror via the wet etching.

12. The method of claim 10, wherein the fabrication process comprises forming the micromirror in the first waveguide via the grayscale lithography, and wherein the micromirror is flat or concave based at least in part on forming the micromirror via the grayscale lithography.

13. The method of claim 10, further comprising:
obtaining a prediction of a level of performance of a three dimensional photonic circuit including the apparatus via a machine learning model.

14. The method of claim 13, wherein the machine learning model comprises a predictive digital twin model configured to predict one or more levels of performance based at least in part on one or more parameters associated with the fabrication process.

15. The method of claim 14, wherein the machine learning model is trained using data associated with the fabrication process.

16. The method of claim 15, wherein the data comprises information pertaining to at least one of the following: one or more materials associated with the first waveguide, one or more materials associated with the second waveguide, one or more angles associated with the micromirror, one or more curvature values associated with the micromirror, a fabrication method used to form the micromirror, one or more types of reflective material deposited on at least one surface of the micromirror, one or more shapes associated with the first waveguide, one or more shapes associated with the second waveguide, or a fabrication method used to couple the first waveguide to the second waveguide.

17. A photonic integrated circuit device, comprising:
at least two waveguide layers;
at least one micromirror configured to transfer an optical signal between the at least two waveguide layers; and
a digital twin system configured to predict one or more performance outcomes based at least in part on one or more parameters associated with a fabrication process used to fabricate at least a portion of the photonic integrated circuit device.

18. The photonic integrated circuit device of claim 17, wherein the portion of the photonic integrated circuit device comprises the at least two waveguide layers and the at least one micromirror.

19. The photonic integrated circuit device of claim 17, wherein the one or more parameters comprise at least one of the following: one or more materials associated with each waveguide layer of the at least two waveguide layers, one or more angles associated with the at least one micromirror, one or more curvature values associated with the at least one micromirror, a fabrication method used to form the at least one micromirror, one or more types of reflective material deposited on at least one surface of the at least one micromirror, one or more shapes associated with at least two waveguides in the at least two waveguide layers, or a fabrication method used to couple the at least two waveguide layers.

20. The photonic integrated circuit device of claim 17, wherein the at least two waveguide layers comprise a first waveguide layer and a second waveguide layer, and wherein the first waveguide layer comprises an in-plane waveguide and the second waveguide layer comprises an out-of-plane waveguide.
